(19) United States
(12) Patent Application Publication
(10) Pub. No.: US 2014/0028516 A1
(43) Pub. Date: Jan. 30, 2014

(54) DUAL-POLARIZED RADIATING ELEMENT WITH ENHANCED ISOLATION FOR USE IN ANTENNA SYSTEM

(71) Applicants: Kostyantyn SEMONOV, Medford, OR (US); Eric A. DYSSEGARD, Ashland, OR (US); Manfred MUENZEL, Eagle Point, OR (US)

(72) Inventors: Kostyantyn SEMONOV, Medford, OR (US); Eric A. DYSSEGARD, Ashland, OR (US); Manfred MUENZEL, Eagle Point, OR (US)

(73) Assignee: KATHREIN, INC., Scala Division, Medford, OR (US)

(21) Appl. No.: 13/558,288

(22) Filed: Jul. 25, 2012

(51) Int. Cl. H01Q 21/26

(52) U.S. Cl. CPC H01Q 21/26
USPC 343/798; 343/797

(57) ABSTRACT

A dual-polarized radiating element having a first dipole and a second dipole attached to a reflector. Each conductive first half dipole and each conductive second half dipole of each of the first and second dipoles having a first surface and an opposite second surface. In one embodiment, the first surface of each first half dipole extends offset to the first surface of the respective second half dipole. Each of dipoles includes a conductive element having a first side portion spaced apart from and secured to the first surface of the respective first half dipole and a second side portion spaced apart from and secured to the first surface of the respective second half dipole, and is connectible to an input signal so as to be capable of being electromagnetically coupled to the first and second dipoles.

### TECHNICAL FIELD

The present disclosure generally relates to radiating elements for use in antenna systems and, more particularly to dual-polarized radiating elements for use in antenna systems.

### BACKGROUND

Radiating elements can be used in antennas to convert electrical currents into radio waves for transmission and/or convert radio waves into electrical currents for reception. Dipole radiating elements, which can be incorporated into dipole antennas, have heretofore been provided. One example of a dipole radiating element is an x-pole radiating element, which in some embodiments orients two dipoles perpendicular to each other to generally form an “x” shaped radiating element capable of transmitting and receiving radio frequency waves on two separate channels with some degree of isolation between channels. It is desirable to provide a radiating element, and an antenna, that provides superior signal isolation between channels.

### BRIEF DESCRIPTION OF THE DRAWINGS

The accompanying drawings are incorporated in and form a part of this specification, illustrate several embodiments and, together with the description, help to explain the embodiments.

FIG. 1 is a perspective view of an antenna including a plurality of dual-polarized radiating elements of the present invention.

FIG. 2 is a perspective view of one of the dual-polarized radiating elements of the antenna of FIG. 1.

FIG. 3 is a top plan view of the dual-polarized radiating element of FIG. 2 taken along the line 3-3 of FIG. 2.

FIG. 4 is a side plan view of the dual-polarized radiating element of FIG. 2 taken along the line 4-4 of FIG. 3.

FIG. 5 is a side plan view of the dual-polarized radiating element of FIG. 2 taken along the line 5-5 of FIG. 3.

FIG. 6 is an enlarged perspective view, similar to FIG. 2, of the dual-polarized radiating element of FIG. 2 with two half-dipoles removed to show the first and second dielectric sheets.

FIG. 7 is a side plan view of the portion of the dual-polarized radiating element of FIG. 6 taken along the line 7-7 of FIG. 6.

FIG. 8 is perspective view of a first dielectric sheet with a conductive element thereon taken along line 8-8 in FIG. 7.

FIG. 9 a plan view of a second dielectric sheet with a conductive element thereon of the dual-polarized radiating element of FIG. 2 taken along the line 9-9 of FIG. 7.

FIG. 10 is a top view of the second dielectric sheet and conductive element of FIG. 9 taken along the line 10-10 of FIG. 9.

FIG. 11 is a perspective view of another embodiment of a dual-polarized radiating element of the present invention.

FIG. 12 is a perspective view of the dual-polarized radiating element of FIG. 11 taken along the line 12-12 of FIG. 11.

FIG. 13 is a top plan view of the dual-polarized radiating element of FIG. 11 taken along the line 13-13 of FIG. 12.

FIG. 14 is a perspective view, similar to FIG. 12, of the dual-polarized radiating element of FIG. 11 with two half-dipoles removed to show the first and second dielectric sheets.

FIG. 15 is a perspective view of a first dielectric sheet with a conductive trace thereon of the dual-polarized radiating element of FIG. 11 taken along the line 15-15 of FIG. 14.

FIG. 16 is a perspective view of a second dielectric sheet of FIG. 15 taken along the line 16-16 of FIG. 14.

FIG. 17 is a top view of the second dielectric sheet of FIG. 16 taken along line 17-17 of FIG. 16.

FIG. 18 is a top plan view of another embodiment of a dual-polarized radiating element of the present invention.

FIG. 19 is a plot illustrating isolation between channels achieved by a conventional x-pole antenna.

FIG. 20 is a plot illustrating isolation between channels achieved by a dual polarized antenna of the present invention.

### DETAILED DESCRIPTION

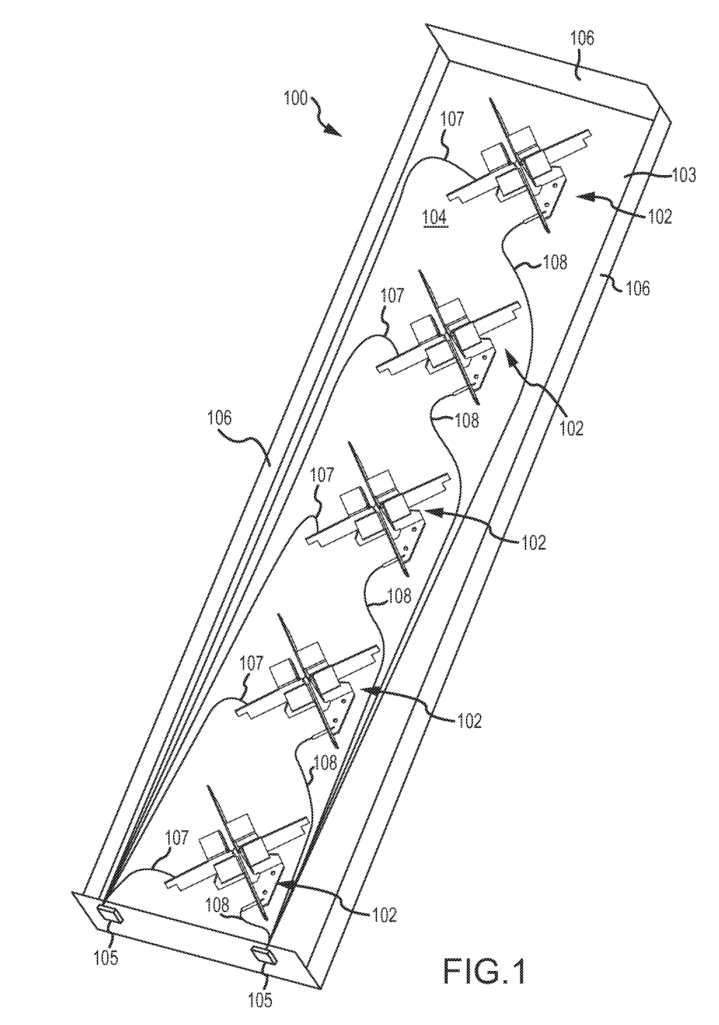

In one embodiment of the invention, an antenna array 100, as shown in FIG. 1, may include a number of radiating elements or antenna radiating elements 102. The array 100 may include any number of antenna radiating elements. As shown, five antenna radiating elements 102 may be provided, while in other embodiments, two, three, four, six or more may be provided. In still other embodiments, a single antenna radiating element may be implemented. Generally, adding antenna radiating elements increases the gain of the array 100. The antenna radiating elements 102 may be configured to convert electrical signals into radio waves for transmission and to convert radio waves to electrical signals for reception. As illustrated, the antenna radiating elements 102 may take the form of dual-polarized radiating elements of the present invention, sometimes referred to as x-pole radiating elements or x-pole antenna radiating elements. In this regard, each of the radiating elements 102 may include two dipoles oriented generally orthogonally to each other. The dual-polarized radiating elements 102 of the present invention are discussed in greater detail below.

The antenna radiating elements 102 may be mounted to a reflector or radiator plate, such as conductive reflector 104 that is configured to reflect radio waves outwardly from its surface, such as surface 103 that can be planar. The conductive reflector or radiator 104 may be configured to be mounted on a pole, wall, or other support structure in accordance with present practice and may be made of a sheet of metal made from any suitable material such as tin-plated copper, aluminum or any other suitable radio reflective material. The conductive reflector 104 may have its edges 106 turned up so that they extend out of the plane of the conductive reflector, for example out of the plane of planar surface 103, for convenience in mounting a radio frequency transparent cover or to achieve a desired reflectance of the radio waves. Each of the antenna radiating elements 102 may be mounted equidistantly from its adjacent antenna radiating elements on the conductive reflector 104. In other embodiments, the antenna radiating elements 102 may be spaced apart at any suitable distance, for example at unequal distances or at a combination of equal and unequal distances.

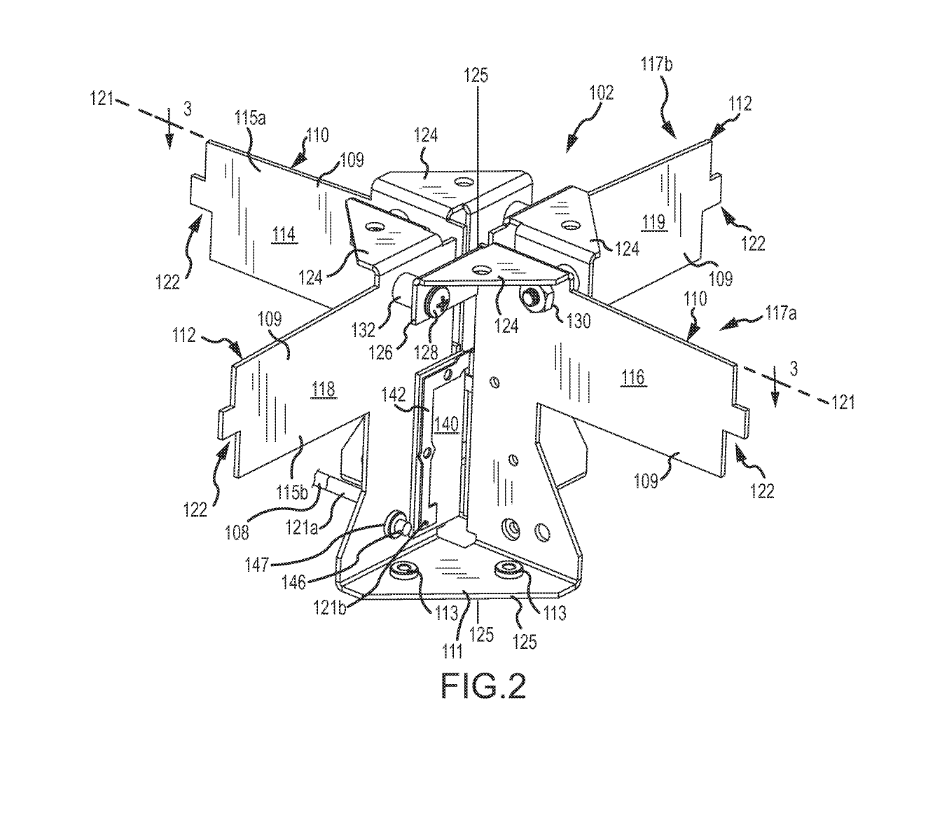

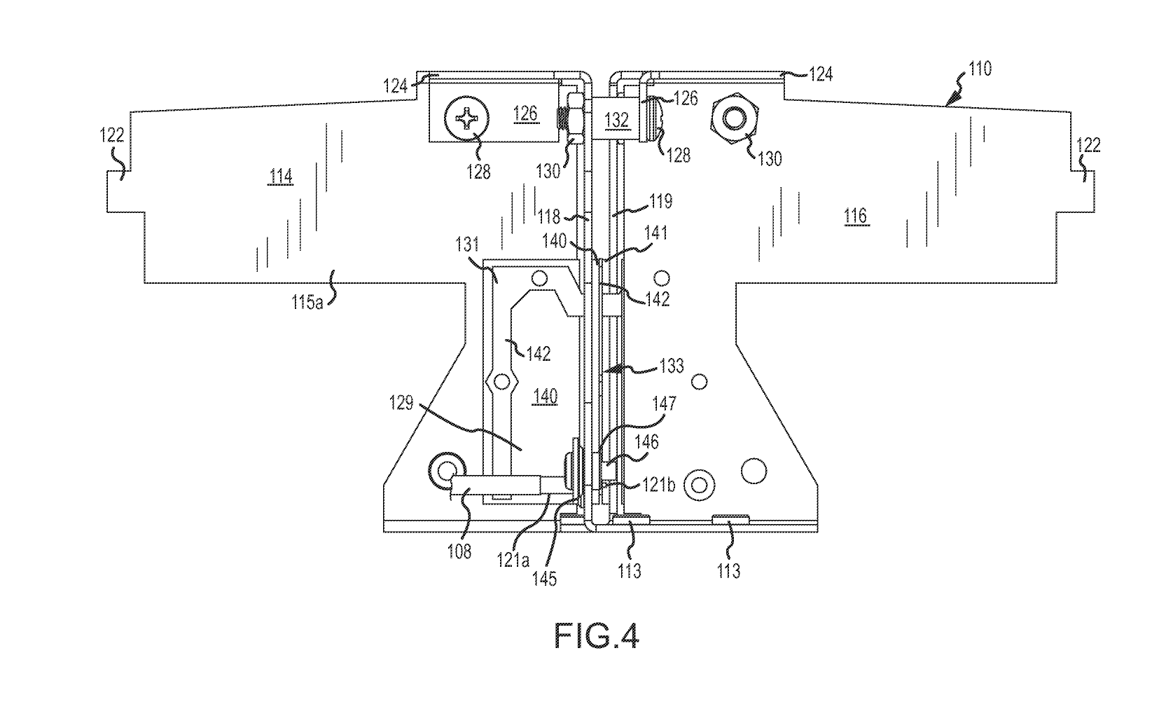

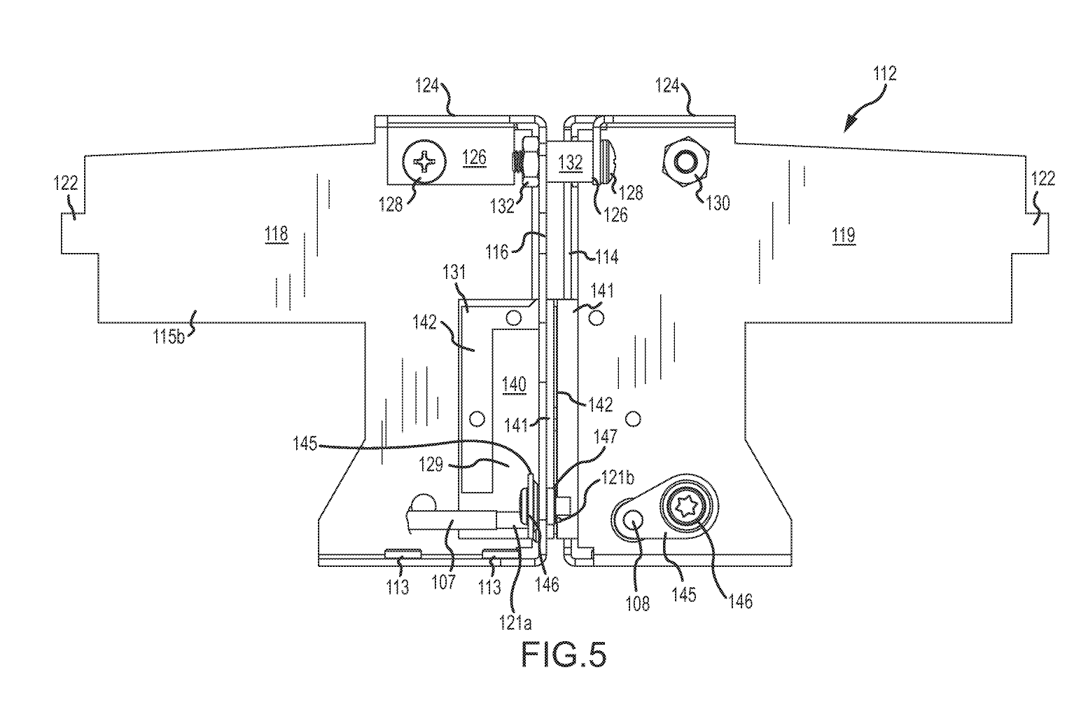

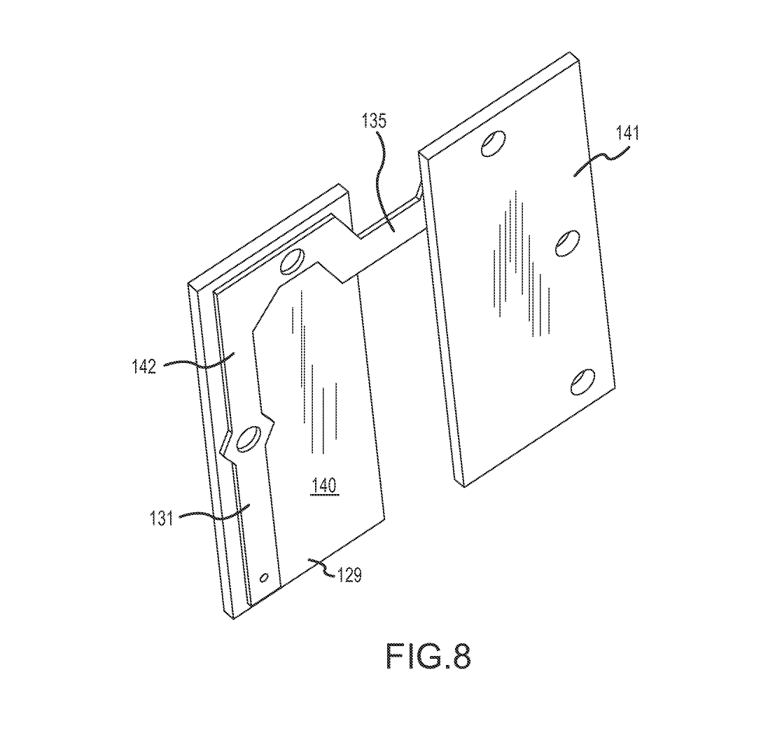

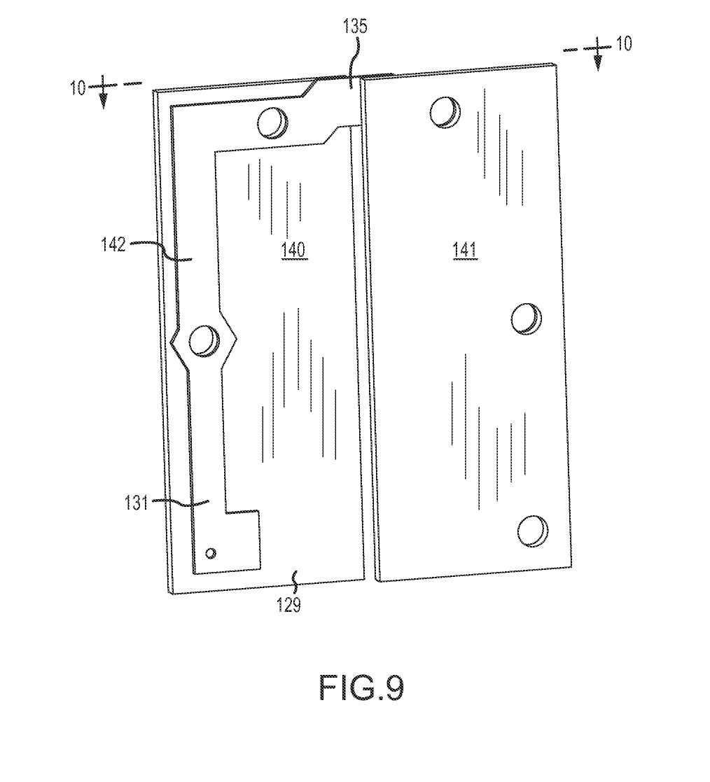

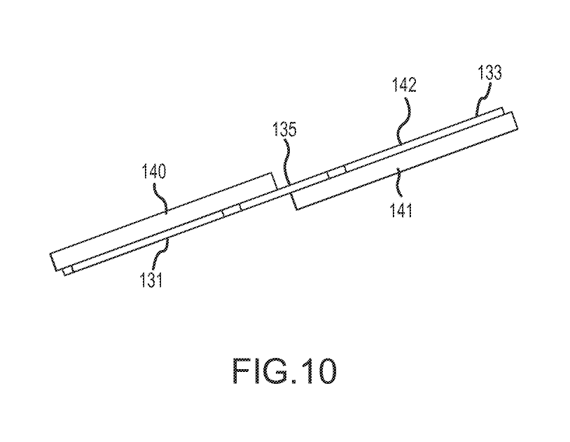

Each radiating element 102 may include first dipole 110 and second dipole 112, which in one embodiment can be inclined relative to each other and in one embodiment are inclined or oriented at approximately 90 degrees relative to each other as shown in FIG. 2. Each of the first and second dipoles 110, 112 may include a half-dipole pair that can be referred to as a pair of half-dipoles. For example, first dipole 110 may include a half-dipole pair such as first half-dipole 114 and second half-dipole 116 as shown in FIG. 2. Similarly, second dipole 112 may include a half-dipole pair such as first half-dipole 118 and second half-dipole 119. The two half-dipoles of each dipole 110, 112 can be configured to extend from the conductive radiator 104, for example surface 103 of the radiator or reflector 104. In one embodiment, each half-dipole of each radiating element 102 extends orthogonally from the reflector 104. In one embodiment, for example in the embodiment illustrated in FIGS. 2-11, the first and second half-dipoles of each first and second dipole 110, 112 can be offset from each other. That is, the first and second half-dipoles may not be coplanar with each other. Rather, the two half-dipoles of each first and second dipole 110, 112 may reside in parallel planes, and thus be parallel but offset relative to each other. Thus for example, first and second half-dipoles 114, 116 of first dipole 110 are offset from each other, and similarly first and second half-dipoles 118, 119 of second dipole 112 are offset from each other. In this regard, each first half-dipole 114, 118 may have a first surface 115 which is offset from a first surface 117 of its corresponding or respective second half-dipole 116, 119. For example, first surface 115a of first half-dipole 114 can be offset relative to first surface 117a of second half-dipole 116, and similarly first surface 115b of first half-dipole 118 can be offset relative to first surface 117b of second half-dipole 119.

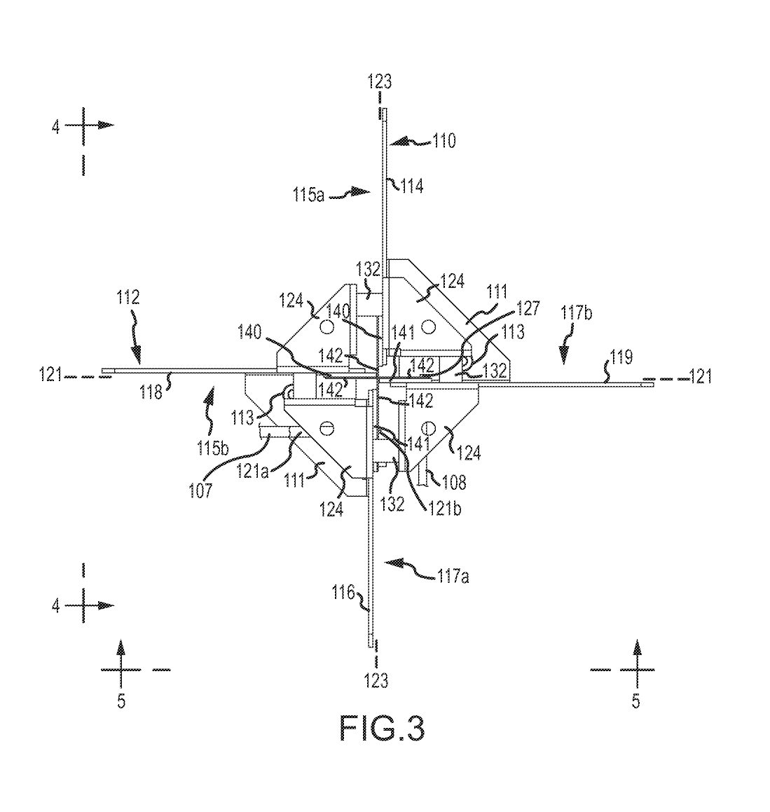

In one embodiment, a first half-dipole of each dipole 110, 112 may be symmetrical with a respective second half-dipole of the dipole about an imaginary plane that extends orthogonal to the conductive reflector 104. For example first half-dipole 114 of the first dipole 110 may be symmetrical with the respective second half-dipole 116 about an imaginary plane 121 extending orthogonally to surface 103 of the conductive reflector 104 (see FIG. 3). Similarly, the first half-dipole 118 of the second dipole 112 may be symmetrical with the respective second half-dipole 119 about an imaginary plane 123 extending orthogonally to surface 103. In one embodiment, the first and second half-dipoles of a half-dipole pair or dipole may be symmetrically disposed about an imaginary line that resides in the imaginary plane. For example, first half-dipole 114 may be symmetrically disposed with respective second half-dipole 116 about an imaginary line 125 that resides or extends in imaginary plane 121 (see FIG. 2) and similarly first half-dipole 118 may be symmetrically disposed with respective second half-dipole 119 about an imaginary line that resides or extends in imaginary plane 123. In one embodiment, the respective conductive element, for example conductive element 142, may reside within the respective imaginary plane, for example imaginary plane 123 as shown in FIG. 3.

The antenna 102 may be constructed of sheet metal, such as tin-plated copper, brass, or aluminum sheets, that is cut and bent to form the half-dipoles of the present invention, such as half-dipoles 114, 116 of first dipole 110. In one embodiment, illustrated in the figures, two adjacent half-dipoles are oriented at approximately 90 degrees from each other and are coupled together at a base 111 that may be used to couple the half-dipoles to surface 103 of the conductive reflector 104. For example, second half-dipole 116 of first dipole 110 and first half-dipole 118 of second dipole 112 can be coupled together at a base 111 as shown in FIG. 2. It should be appreciated that the coupling of two adjacent half-dipoles in this manner allows for two half-dipoles to be formed from a single sheet of metal and may simplify both coupling to the conductive reflector and proper arrangement and alignment of the half-dipoles relative to each other. As such, the radiating element 102 may be constructed from two sheets of metal: one sheet to form half-dipoles 116 and 118, and one sheet to form half-dipoles 114 and 119 (see FIG. 2). In other embodiments, each half-dipole may be independent or distinct from, for example not integral with, the adjacent or adjoining half-dipole of the radiating element 102. The base 111 may couple to the conductive reflector 104 with at least one suitable fastener 113 such as a screw.

Each of the first and second dipoles 110, 112 may generally take the form of two half-dipoles, for example half-dipoles 114, 116 of the first dipole and half-dipoles 118, 119 of the second dipole, configured to extend orthogonally from the conductive radiator 104. Each of the half-dipoles may have several different parts which are described herein. A dielectric sheet can be coupled to the first surface of each first and second half-dipole of each dipole. For example, a dielectric sheet can be coupled to first surface 115 of first half-dipole 114 and first surface 117 of second half-dipole 116 of the first dipole 110, and a dielectric sheet can be coupled to first surface 115 of first half-dipole 118 and first surface 117 of second half-dipole 119 of the first dipole 110. The first surfaces 115, 117 of corresponding half dipoles are generally oriented to face in opposite directions. For example, first surface 115 of each dipole faces in an opposite direction to first surface 117 of such dipole. Each half dipole may have the same shape as the other half dipoles.

Generally, the length of the dipoles 110, 112 define the operative wavelength for the radiating element 102. Stated differently, the distance the half-dipoles of a radiating element 102 extend from a center of the respective dipole 110, 112 (e.g., the length of the half-dipole) is determinative of the range of wavelengths and frequencies for which the antenna radiating element 102 is effective and defines the resonant frequency of the antenna radiating element. In this regard, the operating frequency range of a radiating element is inversely related to the length of the respective half-dipoles so that longer dipoles have lower operating frequencies. In some embodiments, the dipoles may include one or more steps, notches or cutouts 122. The notches, cutouts or steps 122 relate to tuning of the radiating elements and the use of such is known in the art. It should be appreciated that some embodiments may include more or fewer cutouts or steps than those illustrated in the drawings.

First and second feed networks 107, 108 communicatively couple respective first and second dipoles 110, 112 of each of the dual polarized radiating elements 102 to respective first and second radio frequency couplers 105, which can be of any suitable type such as 7/16—DIN connectors. The couplers 105 allow the first and second cables 107, 108, and thus radiating elements 102, to couple to a communication network, such as a cellular communications network (not shown) external to the array 100. As such, each dipole 110, 112 receives it own signal (a plus polarization and a minus polarization). In particular each dipole 110, 112 of the dual-polarized radiating elements may be coupled to one of the feed networks 107, 108, and as shown first feed network 107 is electrically coupled to first dipole 110 and second feed network 108 is electrically coupled to second dipole 112. The feed networks 107, 108 may take any suitable form including for example coaxial cables, striplines, microstrips or any other radio frequency feed structure, and are shown herein as being cables. As may be appreciated, the feed networks or cables 107, 108 may be routed in array 100 and external thereof in a manner that helps minimize interference with the radiating elements 102 of the array 100.

In some embodiments, the half-dipoles may include tuning elements or tabs 124. The tuning members or tabs 124 may be located atop the half-dipoles, opposite the base 111 on the radiating elements of the antennas and oriented orthogonally from the radiating element. Thus, the tuning tabs 124 of each of the half-dipoles may reside in a common plane. Generally, the tuning tabs 124 may be sized and shaped to help tune the antenna with respect to impedance. In one embodiment, a flange 126 may extend downwardly from the tuning structure or tab 124 to allow mechanical coupling of one radiating element to an adjacent radiating element. This mechanical coupling increases the mechanical robustness and rigidity of the assembled antenna 102. A suitable screw, bolt, or other fastener 128 may extend through the flange 126 and an adjacent radiating element. In one embodiment, a nut 130 may be provided to theadedly engage the end of the screw so as to tighten or secure together the flange and adjacent radiating element. Additionally, the screw 128 may pass through a non-conductive sleeve 132 to help maintain a desired distance between the flange 126 and the adjacent radiating element.

The radiating element 102 can include dielectric elements or members, which can be in the form of sheets 140, 141, that are coupled to their respective dipoles 110, 112 of the radiating element 102 (see FIG. 2). In this regard, a first dielectric sheet 140 is provided on a first surface of each first half-dipole 114, 118 of the dipoles 110, 112 and a second dielectric sheet 141 is provided on a first surface of each second half-dipole 116, 119 of the dipoles. Each such first surface can be planar, and opposite a second surface of the respective half-dipole, which can also be planar. With respect to each dipole, the first surface of the first half-dipole is opposite the first surface of the second half-dipole. Each dielectric sheet pair 140, 141 has a conductive element 142 or trace which is configured to feed the dipole. The dielectric sheets 140, 141 may be made of any suitable dielectric material including plastic, ceramic, cloth laminate or air, for example. The dielectric sheets 140, 141 may each have a thickness and the conductive element or strips 142 may each have a width that are matched to provide the proper impedance matching of the radiating element 102, and thus achieve a coupling with radiating element to provide an impedance balance with the respective feed network 107, 108. For example, the conductive strips or elements 142 may be configured to help provide 50 Ohms impedance to match the impedance of the respective feed network 107, 108. The dielectric sheets may be mechanically coupled, connected or secured to the respective half-dipoles of the radiating element in any suitable manner such as with adhesive, fasteners, screws or the like.

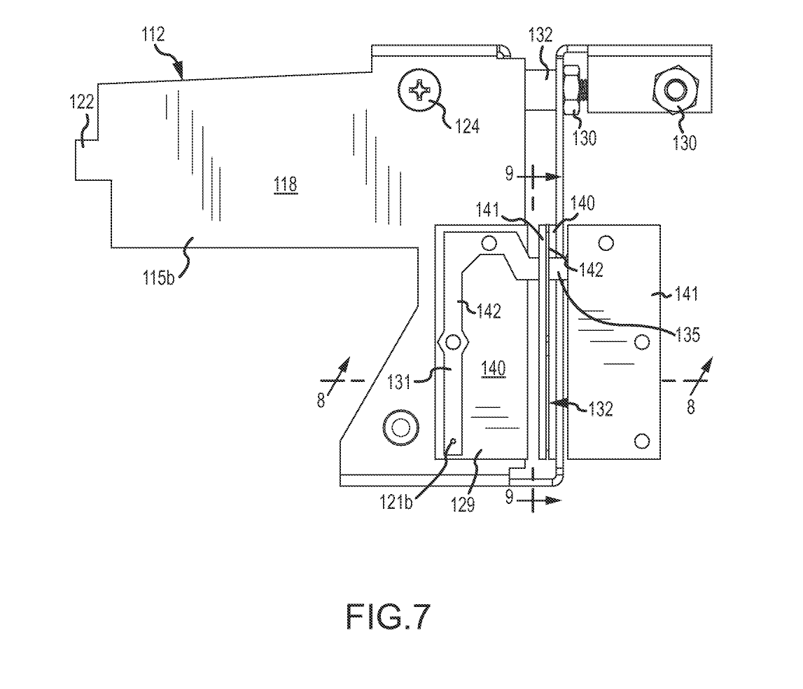

The conductive traces 142 bridge between two half-dipoles and a corresponding dielectric sheet pair, for example between half-dipoles 114, 116 and dielectric sheet pair 140, 141 (see FIG. 3). The top view of the antenna shown in FIG. 3 shows the traces 142 extending between the two half-dipoles of each dipole. The conductive element 142 may be attached to the dielectric sheets 140, 141 in any suitable manner, such as by using an adhesive or integrating the conductive element into the dielectric sheet through partially melting the dielectric sheet, for example. The conductive elements 142 can have a first side portion or strip 131 disposed on an outer surface 129 of a first dielectric sheet 140, a second side portion or strip 133 disposed on the outer surface of a corresponding second dielectric sheet 141 and a central portion or strip 135 extending from and between the tops of first and second side portions 131, 133 and between the dielectric sheets 140, 141 (see FIGS. 7-10).

The conductive element 142 is generally planar and parallel to each dielectric sheet 140, 141 of a dielectric pair and located on respective first or outer surfaces of the dielectric sheets. The first surfaces of the dielectric sheets 140, 141 are oriented in the same direction as the first surface of the half dipole on which the dielectric sheets are mounted. For example, a first surface of the dielectric sheet 140 is oriented in the same direction as the first surface of the half-dipole 114. The outer surface of the dielectric sheets 140, 141 is the surface of the dielectric sheets not disposed against a half-dipole. In some embodiments, an outer surface of a first and second dielectric sheet pair may be co-planar. The half-dipoles 114, 116 are offset from each other and are not co-planar. The offset allows the conductive element 142 to be planar. In one embodiment, the offset may be set by the thickness of the dielectric sheets 140, 141.

It is appreciated that other embodiments for electromagnetically coupling the conductive traces or elements 142 to theirs respective dipoles 110, 112 can be provided and be within the scope of the present invention. For example, one or more of the radiating elements 102 of the antenna array 100 can be provided without dielectric elements or sheets 140, 141. In one such other embodiment, each of the conductive elements 142 is spaced from its respective dipole 110, 112 by an air gap, which serves as the dielectric between the conductive element and the dipole. The conductive element or trace 142 can be secured to the dipole in a position spaced apart or away from the dipole by any suitable means such as by a plurality of rivets or other fasteners made from any suitable dielectric or insulating material. In one embodiment, the conductive element 142 has a first side portion 131 spaced apart from and secured to the first surface 115 of the respective first half dipole 114, 118 and a second side portion 133 spaced apart from and secured to the first surface 117 of the respective second half dipole 116, 119 so as to be electromagnetically coupled to the respective first and second dipole 110, 112. Each conductive element 142 can extend parallel to the respective dipole so as to be spaced from the first surface 115, 117 of the dipole a constant distance across its length and width. When the dielectric of the radiating element is air, an air-stripline is a particular suited embodiment of the feed network 107, 108 for each of the dipoles 110, 112 of the radiating element 102.

Each conductive element 142 is electromagnetically coupled to its respective dipole 110, 112, and as such the conductive elements 142 may be part of a feed and balun unit for the radiating element 102. The conductive elements 142 may take any suitable form and be of any suitable type, such as conductive traces or a templated or stamped conductive metal such as copper. The shape, length and width of the elements or traces 142 may be adjusted to achieve the proper impedance match.

The first and second feed networks or cables 107, 108 are respectively coupled to each dipole 110, 112 of the radiating elements 102 of the array 100, and thus respectively coupled to the first half-dipoles 114, 118 and second half-dipoles 116, 119 of the radiating elements 102 of the array 100. More specifically, a cable 107, 108 is electrically coupled to the feed and balun unit of the respective dipole 110, 112. This may be referred to as launching, as the coupling of the coaxial cable to the dipole allows for a signal carried by the cable to be transmitted by the dipole. In particular, in the case of a cable 107, 108 that is a coaxial cable having a braid 121a and a center wire 121b, the center wire 121b is electrically connected to the conductive element 142 of the respective dipole 110, 112. Cable braid 121a may be connected to a solderable tab or launch 145 which is attached to the dipole with a suitable fastener for creating a ground path. Such fastener may be in the form of a screw 146 and a nut, such as a self clinching nut 147. The center conductor or wire 121b of the cable 107, 108 is conductively attached to conductive element 142 of the respective feed and balun unit of the dipole 110, 112 by any suitable means such as solder, and in one embodiment extends through the launch or launch tab 145 and respective dielectric sheet 140, 141 so as to engage the conductive element.

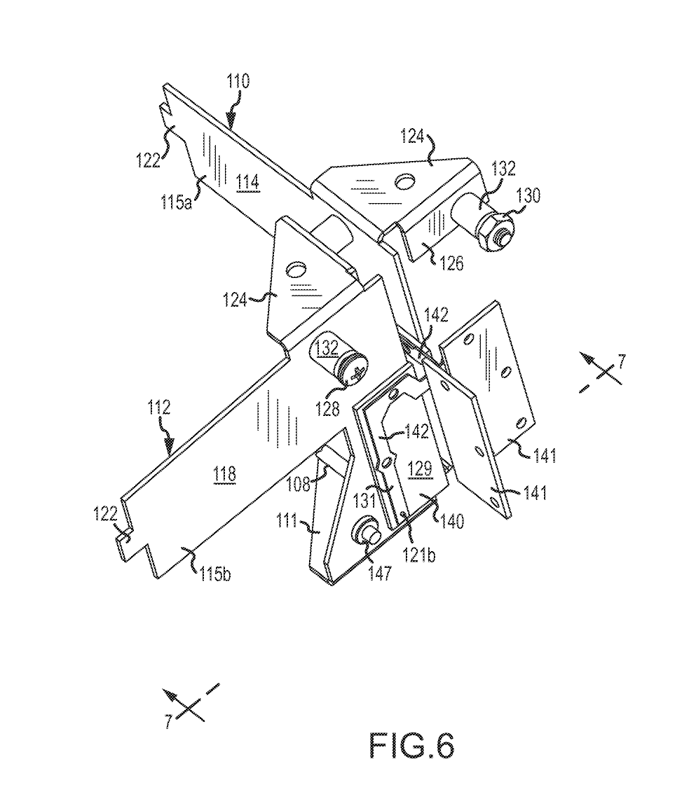

Each conductive element 142 is shielded from other conductive elements. The shielding is achieved by each quadrant of radiating element 102 only including a portion of one conductive element 142. For example, as shown in FIG. 3, a portion of the conductive element 142 associated with half-dipole 114 faces the half-dipole 118 and not another portion of a conductive trace. That is, the portion of conductive element 142 associated with half-dipole 114 is shielded by the half-dipole 118 from another conductive element 142. As such, each portion of the conductive elements 142 is shielded from other portions of conductive elements by at least a half-dipole. This shielding may help increase channel to channel isolation between dipoles, and thus channels, of the radiating element 102. FIG. 6 also shows the shielding of the conductive traces 142, as no two traces face each other or are co-present in a quadrant of the radiating element.

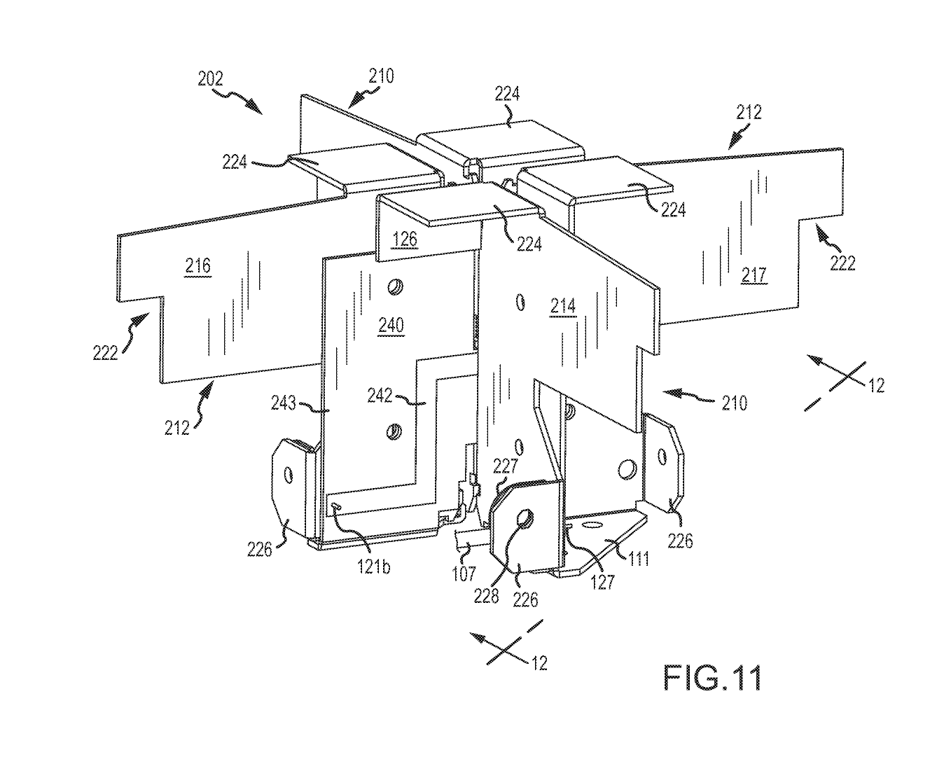

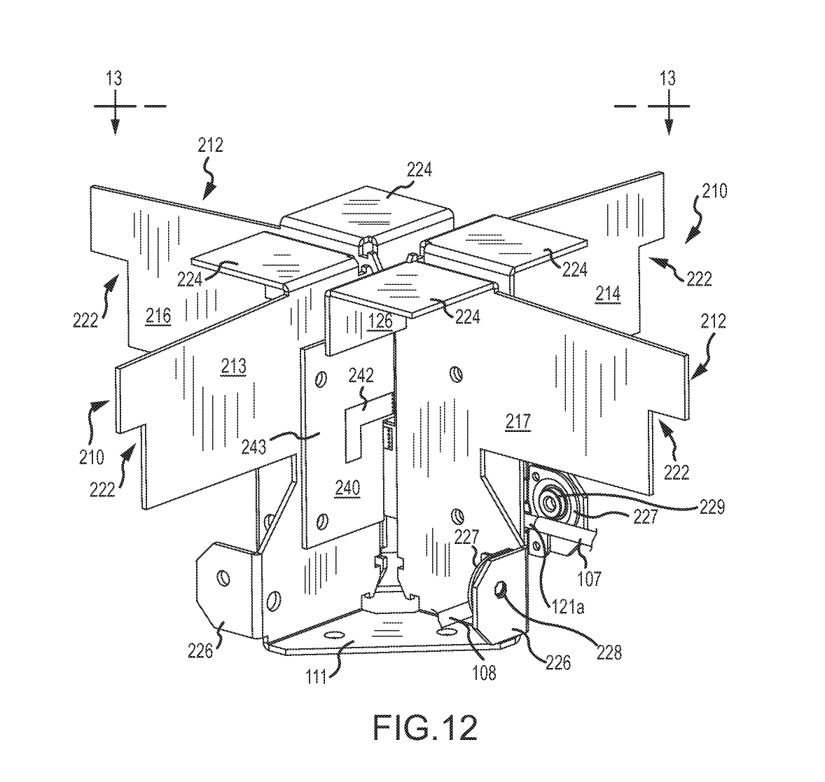

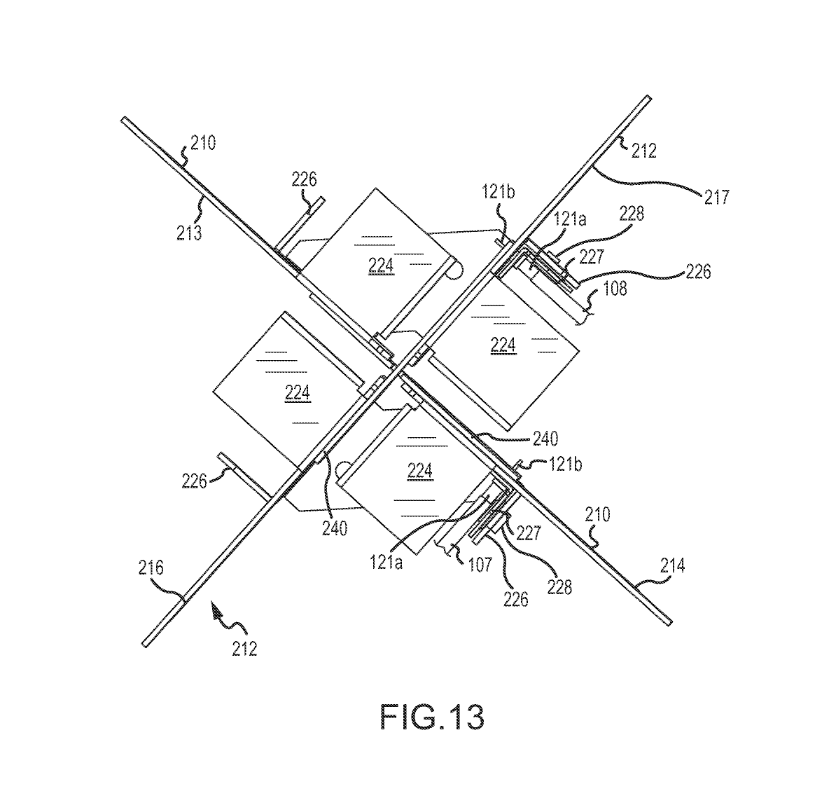

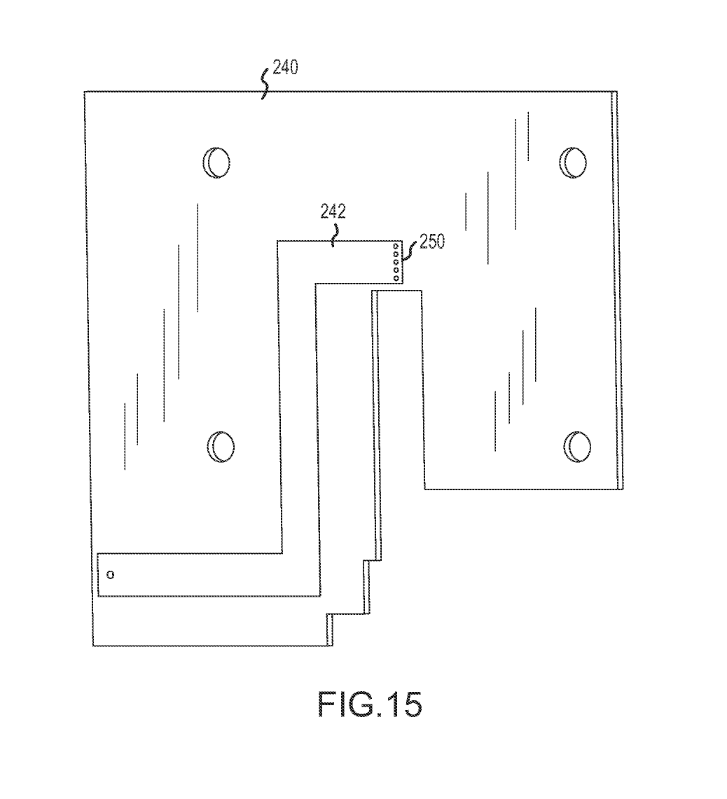

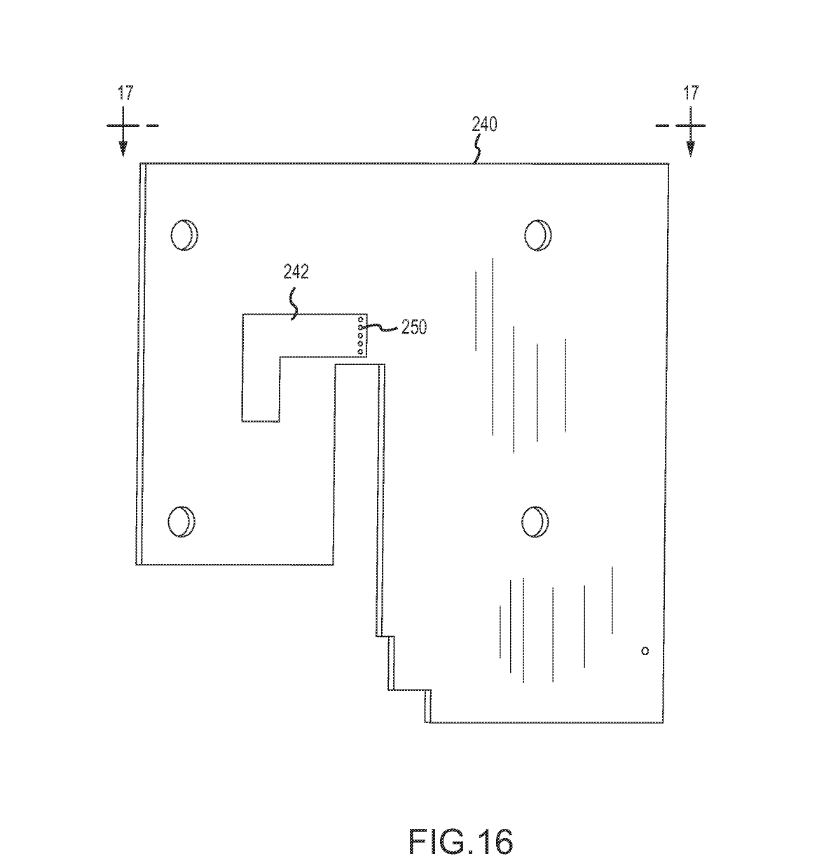

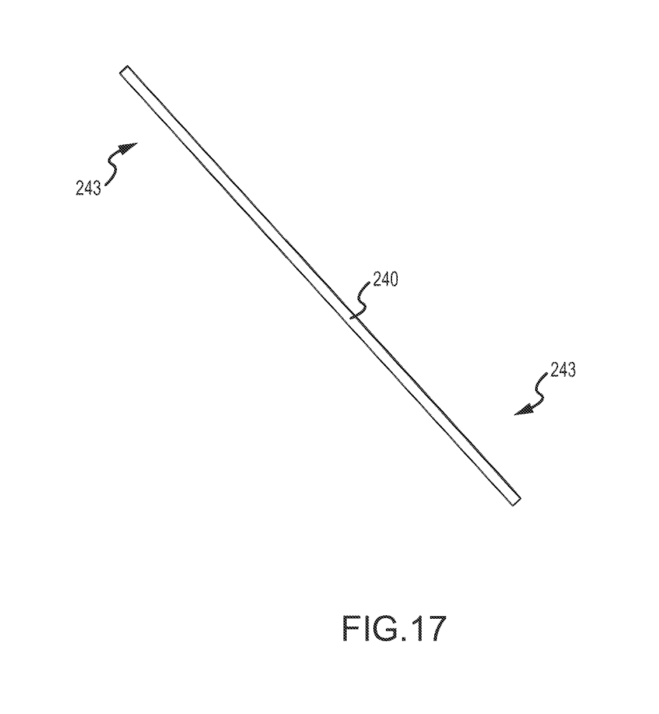

In some embodiments, the dielectric sheets may be a unitary, flat dielectric sheet. That is, a single dielectric sheet may extend between two corresponding half-dipoles of a dipole. FIGS. 11-17 illustrate an example embodiment having such dielectric sheets. In particular, the dielectric sheets 240 may take the form of a printed circuit board with electrically conductive traces 242 formed thereon. The traces 242 may pass through vias 250 in the board so that the trace remains on an exposed surface 243 of the dielectric sheet 240 relative to the half-dipoles. That is, the traces 242 are not on a portion of the dielectric sheet 240 that is coupled to or adjacent to a half-dipole. As such, an exposed surface 243 of the dielectric sheet may be a portion of a first surface of the dielectric sheet directed away from a first half-dipole and a portion of a second surface of the dielectric sheet directed away from a second half-dipole of a dipole. FIG. 17 shows that the exposed surfaces 243 are located near opposite ends and on opposite sides of the dielectric sheet 240.

The embodiment illustrated in FIGS. 11-17 includes many of the same or similar features to the prior described embodiment. Like reference numerals are used to describe like components of radiating elements 102 and 202. For example antenna 202 includes a dual-polarized radiating element 202, such as an x-pole antenna, having first and second dipoles 210, 212 each similar to first and second dipoles 110, 112 described above and having a half-dipole pair similar to the half-dipole pairs described above. For example, first dipole 210 can have a half-dipole pair comprised of first and second half-dipoles 213, 214 and second dipole 212 can have a half-dipole pair comprised of first and second half-dipoles 216, 217. Each half-dipole is configured to be mounted to and extend orthogonally from a conductive reflector. Additionally, each half-dipole includes tuning tabs 124 and coupling flanges 126. Further, a base 111 is provided to attach adjacent half dipoles to a reflector plate. FIG. 11 illustrates adjacent or adjoining half-dipoles 214 and 217 being attached together by base 111.

In the illustrated embodiment, mounting tabs 226 may be provided near the base 111 of the radiating element to allow coupling of the dipoles 210, 212 to the feed network or cables 107, 108. In one embodiment, the mounting tabs 226 may take the form of a flange that extends orthogonally to each half-dipole of the dipoles 210, 212 and the tuning tabs 224. A launch tab or launch 227 may be secured to a mounting tab 226 for each dipole 210, 212 for coupling to the respective cable 107, 108. The launch 227 can be secured to the tab 226 by any suitable means such as a screw 228 and self-clinching nut 229 or any other suitable fastener. The braided portion 121a of the cable may be soldered or otherwise joined to the launch 227 and the cable wire 121b can be secured to the conductive element or traces 242 of the feed and balun unit of the respective dipole 210, 212 by solder or any other suitable means.

As shown, each half dipole 213, 214, 216, 217 can include steps, such as steps 222 to help tune the radiating elements. As described above, the length of the dipoles determines the range of the frequencies over which the radiating element 202 is effective. It should be appreciated that the dipoles may take any suitable shape to achieve a desired effective frequency range and as such, the shape illustrated in the drawings is presented merely as an example.

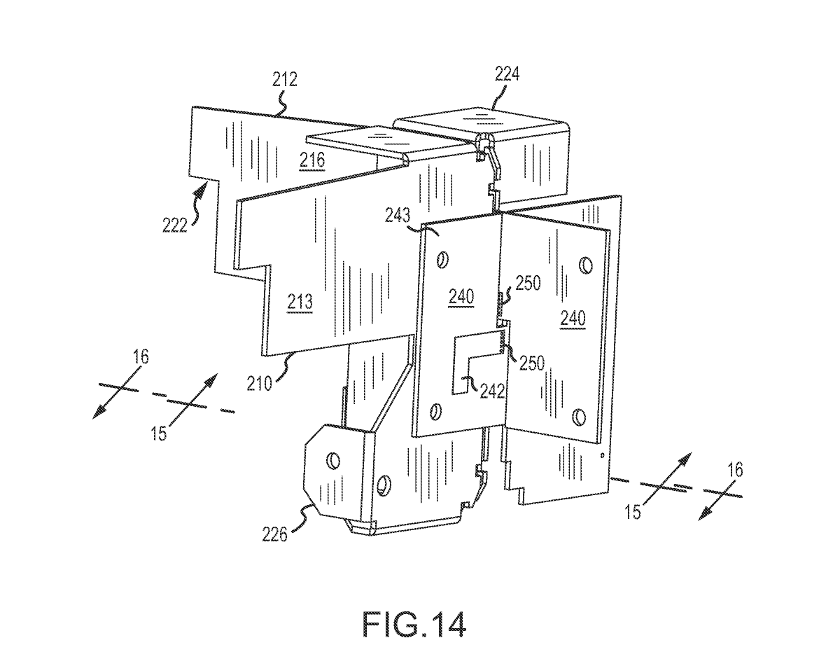

A generally flat dielectric member 240 may extend between two half-dipoles of a dipole. A conductive element 242 may extend over the dielectric member 240 and may include a radio frequency or RF feed and balun unit. In particular, the dielectric member 240 may take the form of a printed circuit board (PCB) and the conductive element 242 may be a trace on the PCB, such as a copper trace. The conductive element 242 may pass through vies 250 on the dielectric member 240 so that they remain on an exposed side or outer side of the dielectric member (see FIGS. 14-16). That is, the conductive elements 242 are disposed on a first side on a first half of the dielectric member 240 and on a second side of a second half of the dielectric member and passes through vias in the dielectric member to do so. Hence, the conductive elements 242 are not directly adjacent to the half-dipoles but rather the dielectric member 240 separates the conductive traces from the half-dipoles.

The vias 250 may be formed through conventional techniques and multiple vias may be provided to maintain a desired impedance matching level. That is, the multiple vias 250 may be provided to maintain a generally consistent cross-sectional area for the conductive member. The conductive traces 242 may be located on a surface of the dielectric member 240, or they may be recessed slightly into the surface of the dielectric 240. (see FIG. 17). That is, in some embodiments, the conductive element 242 may not extend or protrude from the surface of the dielectric member 240.

The dielectric member 240 may extend orthogonally from a conductive reflector and parallel to a plane which is orthogonal to the conductive reflector. The two half-dipoles of a dipole may be symmetrically oriented about the dielectric member. Additionally, each half-dipole of a dipole 210, 212 may be planar and parallel to the imaginary plane that extends orthogonally from the conductive reflector. As such, each half-dipole may be parallel to the dielectric member. Moreover, as the dielectric member 240 extends between the two half-dipoles and is coupled to the two half-dipoles, the dielectric member defines the offset distance of the half dipoles. Generally, standard PCB thickness may be used. For example, the offset distance may be 1/16 of an inch based on a standard 1/16 of an inch thickness of a PCB. In other embodiments, the offset may vary. It should be appreciated that if the thickness of the dielectric member 240 changes, the size of the traces will correspondingly need to change in order to maintain the desired coupling with the half-dipoles and to provide the desired impedance. For example, if the dielectric member is thicker, the conductive element will become wider. In addition to offsetting the half-dipoles from residing in a common plane, the use of a planar dielectric member with conductive traces as provided herein, allows for no conductive traces to be adjacent to each other or facing each other. Rather, each conductive trace is shielded from other conductive traces by at least a half-dipole.

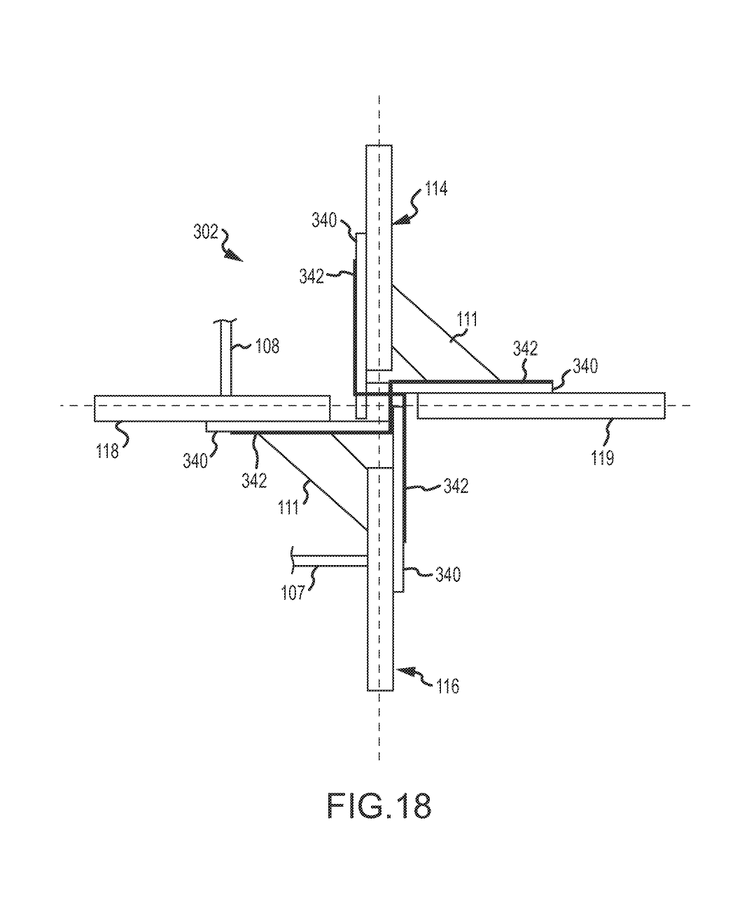

In some embodiments, the half-dipoles of a dipole may be coplanar. That is, for example there may be no offset between the half-dipoles. FIG. 18 is a top view of a dual polarized antenna 302 having planar dipoles (e.g., corresponding half-dipoles are coplanar). Like reference numerals are used to describe like components of radiating elements 102 and 302. For example, the antenna 302 includes a base 111 for coupling to a reflector plate such as reflector plate 104. The base 111 may also mechanically couple two half-dipoles together. Additionally, the half-dipoles 114, 116, 118, 119 may generally take the same or similar form as that set forth in the embodiment of FIGS. 2-10. More specifically, a radiating element of the half-dipoles 114, 116, 118, 119 may take the same form as that discussed above.

As shown, half-dipoles 114, 116 may straddle a common plane and, similarly, half-dipoles 118, 119 may straddle a common plane. Dielectric members 340 may be configured to accommodate the co-planar half-dipoles and conductive elements 342 may be routed on the dielectric members and in between the half-dipoles. In particular, the conductive element 342 may again be coupled to an outer side 344 of the dielectric member 340 to electromagnetically couple with the half-dipoles. The dielectric members 340 may take any suitable form, such as cloth laminate, ceramic, air, or a plastic. Additionally, the dielectric members may be fused together, adhered together or otherwise mechanically coupled to each other. The conductive elements 342 may also take any suitable form such as a conductive trace adhered or bonded to the dielectric members 340.

In this configuration, as with the other embodiments, the conductive traces 342 are generally shielded from each other. That is, no two conductive traces 342 face each other or are predominant within the same quadrant of the radiating element 302. Each conductive trace 342 faces a radiating element of an adjacent half-dipole and, thus, a half-dipole is located between each portion of a first conductive trace and a portion of another conductive trace.

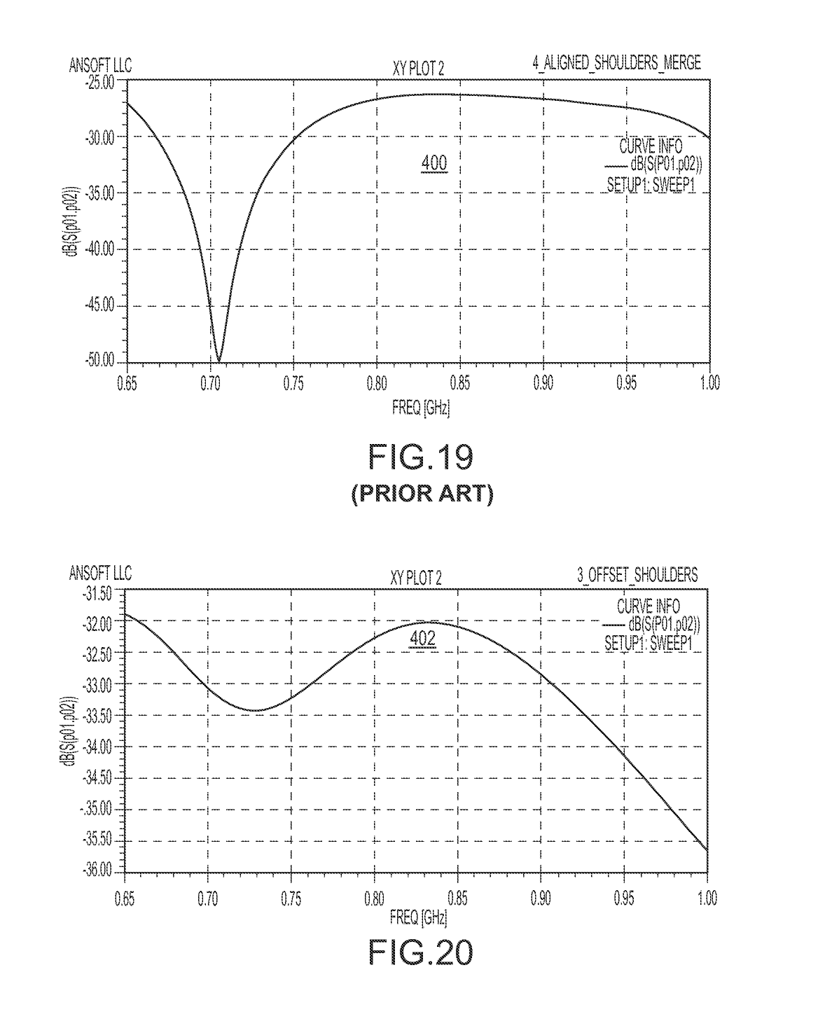

Generally, the embodiments disclosed herein provide antennas that radiate a carrier signal with improved fidelity over conventional antennas. The improved fidelity may be achieved by improving isolation between radiating elements using for example a unique feed and balun structure. A conventional x-pole antenna and an x-pole antenna in accordance with the present embodiments were each modeled in software using a high-frequency structure simulator (HFSS). Generally, 3D models of the antennas were transported into the software and characteristics were given for the respective antennas. Results from the modeling are shown in FIGS. 19 and 20. FIG. 19 is a plot 400 illustrating the isolation achieved from the conventional x-pole antenna and FIG. 20 is a plot 402 illustrating the isolation achieved from an x-pole antenna with offset half-dipoles and shielded conductive elements. In each plot, the horizontal axis is the frequency in gigahertz and the vertical axis is the isolation between channels measured in decibels. As may be seen, the plot 402 shows an approximately 6 dB isolation improvement achieved by the present antennas over the conventional antennas in the 698 MHz to 894 MHz band. Hence, the presently disclosed antennas provide improved performance.

The foregoing describes some example embodiments of radiating elements that may provide superior performance over conventional radiating elements. This may result, in part, from shielding that is provided by the dipole arrangement relative to baluns. Although the foregoing discussion has presented specific embodiments, persons skilled in the art will recognize that changes may be made in form and detail without departing from the spirit and scope of the embodiments. In particular, those skilled in the art will appreciate that it is possible to modify the size, shape, appearance and methods of manufacture of various elements, or to include or exclude various elements and stay within the scope and spirit of the present disclosure. Accordingly, the drawings and detailed description are to be regarded as illustrative in nature and not restrictive.

We claim:

1. A dual-polarized radiating element, comprising a conductive reflector, a first dipole and a second dipole attached to the reflector, the first dipole being substantially orthogonal to the second dipole, each of the first dipole and the second dipole being formed from a conductive first half dipole and a conductive second half dipole, each first half dipole and each second half dipole having a first surface and an opposite second surface, the first surface of each first half dipole extending offset to the first surface of the respective second half dipole, a first conductive element having a first side portion spaced apart from and secured to the first surface of the first half dipole and a second side portion spaced apart from and secured to the first surface of the second half dipole, a second conductive element having a first side portion spaced apart from and secured to the first surface of the second half dipole and a second side portion spaced apart from and secured to the first surface of the second half dipole, the first conductive element being connectible to a first input signal so as to be capable of being electromagnetically coupled to the first dipole and the second conductive element being connectible to a second input signal so as to be capable of being electromagnetically coupled to the second dipole.

2. The radiating element of claim 1, wherein the conductive element is a feed and balun unit

3. The radiating element of claim 1, wherein an imaginary plane extends outwardly from the conductive reflector, each first half dipole being symmetrically disposed relative to the imaginary plane with respect to the respective second half dipole.

4. The radiating element of claim 3, wherein an imaginary line extends outwardly from the conductive reflector, the imaginary line being within the imaginary plane and each first half dipole being symmetrically disposed relative to the imaginary line with respect to the respective second half dipole.

5. The radiating element of claim 3, wherein the conductive reflector has a planar surface and the imaginary plane extends orthogonally from the planar surface.

6. The radiating element of claim 1, further comprising a first dielectric sheet disposed on the first surface of each first half dipole and having an outer surface and a second dielectric sheet disposed on the first surface of each second half dipole and having an outer surface, the first side portion of each of the first and second conductive elements being disposed on the outer surface of the respective first dielectric sheet so as to be secured to the first surface of the respective first half dipole by means of such first side portion and the second side portion of each of the first and second conductive elements being disposed on the outer surface of the respective second dielectric sheet so as to be secured to the first surface of the respective second half dipole.

7. The radiating element of claim 6, wherein each first half dipole and second half dipole are planar and wherein each first dielectric sheet and second dielectric sheet are planar.

8. The radiating element of claim 6, wherein the outer surface of each first dielectric sheet and respective second dielectric sheet are planar.

9. The radiating element of claim 8, wherein the conductive element is planar.

10. The radiating element of claim 1, wherein the first surface of each second half dipole is parallel but offset to the first surface of the respective first half dipole.

11. A dual-polarized radiating element, comprising a conductive reflector, a first dipole and a second dipole attached to the reflector, the first dipole being substantially orthogonal to the second dipole, each of the first and second dipoles being formed from a conductive first half dipole and a conductive second half dipole, each first half dipole and each second half dipole having a first surface and an opposite second surface, each of the first and second dipoles having a conductive element having a first side portion spaced apart from and secured to the first surface of the respective first half dipole and a second side portion spaced apart from and secured to the first surface of the respective second half dipole so as to be electromagnetically coupled to the respective first and second dipole, the conductive element of the first dipole being shielded from the conductive element of the second dipole by the conductive first half dipole and conductive second half dipole of the second dipole.

12. The radiating element of claim 11, wherein each first half dipole is substantially planar and each second half dipole is substantially planar.

13. The radiating element of claim 11, wherein each first half dipole extends in a plane and each respective second half dipole extends in a plane that is parallel and offset from the plane of the first half dipole.

14. The radiating element of claim 11, further comprising a first dielectric sheet disposed on the first surface of each first half dipole and having an outer surface and a second dielectric sheet disposed on the first surface of each second half dipole and having an outer surface, the first side portion of the conductive element being disposed on the outer surface of the respective first dielectric sheet so as to be secured to the first surface of the respective first half dipole by means of such first side portion and the second side portion of the conductive element being disposed on the outer surface of the respective second dielectric sheet so as to be secured to the first surface of the respective second half dipole.

15. An antenna, comprising a plurality of x-pole radiating elements coupled to a conductive reflector, each x-pole radiating element comprising a first dipole and a second dipole, the first dipole being substantially orthogonal to the second dipole, each of the first and second dipoles comprising a conductive first half dipole and a conductive second half dipole, each first half dipole and second half dipole having a first surface and an opposite second surface, each of the first and second dipoles having a conductive element having a first side portion spaced apart from and secured to the first surface of the respective first half dipole and a second side portion spaced apart from and secured to the first surface of the respective second half dipole so as to be electromagnetically coupled to the respective first and second dipoles, the conductive element of the first dipole being shielded from the conductive element of the second dipole by the conductive first half dipole and conductive second half dipole of the second dipole.

16. The antenna of claim 15, further comprising a feed network, wherein the conductive elements and the feed network are configured to electrically balance the radiating element.

17. The antenna of claim 15, further comprising a first dielectric sheet disposed on the first surface of each first half dipole and having an outer surface and a second dielectric sheet disposed on the first surface of each second half dipole and having an outer surface, the first side portion of the conductive element being disposed on the outer surface of the respective first dielectric sheet so as to be secured to the first surface of the respective first half dipole by means of such first side portion and the second side portion of the conductive element being disposed on the outer surface of the respective second dielectric sheet so as to be secured to the first surface of the respective second half dipole.
